(19) United States
(12) Patent Application Publication
(10) Pub. No.: US 2025/0155243 A1
(43) Pub. Date: May 15, 2025

(54) A METHOD OF OPERATING A WIRELESS LOGGER DEVICE

(71) Applicant: CONTROLANT HF., Kopavogur (IS)

(72) Inventor: Erlingur BRYNJULFSSON, Kopavogur (IS)

(21) Appl. No.: 18/839,930

(22) PCT Filed: Feb. 22, 2023
(86) PCT No.: PCT/EP2023/054437

§ 371 Date: Aug. 20, 2024

(30) Foreign Application Priority Data
Feb. 23, 2022 (EP) 22158318.0

(51) Int. Cl. G01C 21/20; G08C 17/02

(52) U.S. Cl. CPC G01C 21/20; G08C 17/02

(57) ABSTRACT

A method is provided for operating a wireless logger device at least prior to placing the logger device in a transport mode where the logger device is configured to monitor an environmental-related parameter of an asset while the asset is transported from an origin location to a destination location. The method includes setting the logger device in a first low-power mode where the environmental-related parameter is measured by the sensing device; identifying if there is a deviation in the measured environmental-related data: checking if the logger device is to be set to a transport mode, where in case the checking results in that the logger device is to be set to a transport mode, setting the logger device to a transport mode and adjusting a communication frequency with the external data processing device to a second-time frequency, the second-time frequency being larger than the first-time frequency

### FIELD OF THE INVENTION

The present invention relates to a method of operating a wireless logger device where the logger device is configured to monitor an environmental related parameter of an asset while the asset is being transported from an origin location to a destination location.

### BACKGROUND OF THE INVENTION

With the expansion and growth of global sourcing in the supply chain industry, more prevalent interest has been placed on automatic electronic monitoring of environment related parameters to increase food and drug safety and improve food defense systems throughout all areas of production, processing, storage, transportation and operations over time. Food and drug require proper handling of environment related parameters such as temperature during transport in the supply chain to assure shelf quality, longevity, and safety.

Logger devices are electronic monitoring devices commonly used for these purposes, namely, to be associated with an asset to automatically monitor and record various environmental related parameters of the asset throughout a supply chain, such as temperature, humidity, acceleration, and air pressure over time. A recent example of the importance of such logger devices is the temperature monitoring of the COVID-19 vaccines, which is a critical monitoring parameter.

Logger devices today are transported from the destination location after use to a service center, where they are returned and charged and in some instances are re-calibrated, and then transported back to their origin location. The path from the destination location to the service center is not important for the customer because the monitoring of the asset is completed. Also, the transport from the service center to the original location is often relatively short and the logger devices are in a low power mode during the transport therefore this path is also not critical.

At the origin location, the logger devices are stored until another transport to a destination location starts. During this time, the logger devices remain in low power mode, but “wake-up” with regular time intervals, commonly every 12 hours, to check with an external data processing device, which may be seen as a cloud platform, if an asset order is in place or not. If an asset order is in place, the logger devices receive and store the asset details contained in the asset order, such as what to monitor, what boundaries are allowed, the origin and destination locations etc.

This wake-up frequency at the origin location prior to the transport is amongst others used to ensure that e.g., if an operator when preparing the logger device for transport forgets to manually start a logger device and the logger device together with the asset go into transport, the regular wake-up feature can be used to detect said event.

A common problem today is that the storing time at the origin location (which can be a warehouse) until the actual transport in the supply chain starts can range from several hours, to several days, weeks, or even months. During this time, the logger devices wake-up with a fixed frequency, e.g. said 12 hours, where the modem of the logger device is tuned to change from being in a low-power mode to a high-power mode so that it can communicate with said external data processing device via cellular network. However, this operation is energy consuming and after several months results in significant power use.

Many customers have as a requirement that the battery life of the logger devices when the actual transport starts is not below 90% to ensure sufficient charge for monitoring during the supply chain. This means that all logger devices below this value are not allowed to enter the transport and instead need to be re-charged. This is both tedious and time consuming because these logger devices must be shipped back to the service center for re-charging and then be shipped back to the origin location.

Therefore, it is highly important that battery usage during this critical storage time is minimized.

### SUMMARY OF THE INVENTION

It is an object of the embodiments of the invention to provide a method that minimizes energy consumption of power sources such as batteries used in powering wireless logger devices, in particular when the logger devices are not yet in a transport mode.

In general, the invention preferably seeks to mitigate, alleviate or eliminate one or more of the above-mentioned disadvantages of the prior art singly or in any combination. In particular, it may be seen as an object of embodiments of the present invention to provide a method for improving power source lifetime of the logger device thus solving the above-mentioned problems or other problems.

To better address one or more of these concerns, in a first aspect of the invention, a method is provided for operating a wireless logger device where the logger device is configured to monitor an environmental related parameter of an asset while the asset is transported from an origin location to a destination location, where the logger device comprises:
a power source for powering the logger device,
a storage medium,
a sensing device for sensing an environmental related parameter of the asset,
a communication module,
a processor for operating the power source, the storage medium, the sensing device and the communication module,
   the method comprising:
setting, by the processor, the logger device in a first low-power mode where the environmental related parameter is measured by the sensing device and where the resulting environmental related data is stored in the storage medium, where during the low-power mode the communication module communicates with an external data processing device with at least one first-time frequency by means of temporarily setting the logger device to a first higher-energy mode during the communication with the external data processing device,
   wherein the method further comprises:
detecting if an event is sensed by the sensing device, where in case an event is sensed:
adjusting, by the processor, the logger device to a second higher energy mode and:
   checking if the logger device is to be set to a transport mode, where in case the checking results in that the logger device is to be set to a transport mode,
   setting the logger device to a transport mode and adjusting the communication frequency with the external data processing device to a second-time frequency, the second-time frequency being larger than the first-time frequency.

Thus, by adjusting the logger device from being in the first low-power mode, which may be the sleep mode, to the second higher energy mode, which may be understood as the “wake-up” mode, when such an event is sensed, the number of unnecessary “wake-up's” of the logger device may be reduced or avoided and therefore the power use of the logger device. Thus, instead of e.g. once a day fixed wake-up frequency the wake-up frequency may e.g. be once every seven days. Thus, if no such event is detected there will be no wake-up until these 7 days' period lapses. By reducing the frequency of this energy consuming process, the power usage of the power source in the logger device is reduced greatly meaning that despite e.g. several weeks or months of storage before the transport from the origin location to the destination location the change in the battery life of the logger device will be insignificant. It should, however, be noted that it is important that there is some wake-up frequency present, simply to indicate the status of the logger device is working, e.g. to indicate the power charge, and the temperature, and simply to show that the logger device is working properly.

The step of communicating with the external data processing device with at least one first-time frequency may be a single communication frequency where the logger device wakes up e.g. once every 7 days to communicate with the external data processing device, but this temporal wake-up mode may last in some instances around 60 seconds, depending on environmental conditions such as the signal strength.

The term asset may according to the present invention be understood as any type of goods such as medicine, food, or beverages, that may be packed into packaging material such as a box, a cardboard box, or any type of packaging material or means, that may even be placed into a container, where the asset is subsequently transported by any type of transport means, such as, but not limited to, an aircraft, any type of vehicle, ship, drone device etc., i.e. any means that is capable of transporting the asset from the origin destination to the final destination, where during this transport, the logger device communicates with the external data processing device the position of the asset and at least one measured environmental related data measured by the sensing device or devices e.g. in real time.

In an embodiment, the at least one first-time frequency is selected from two or more gradually decreasing frequencies until a minimum first-time pre-defined frequency is reached. This may be the scenario where the logger device has just arrived at the origin location (e.g. warehouse of the customer) after transport from the service center, where it was fully charged. The fact that it can be very variable how long the logger device (there are typically thousands or tens or even hundreds of thousands of logger devices at such warehouses) will be there until it is used and put into transport mode and the actual transport starts may vary from being several hours, up to days, weeks or even months. Thus, it may be beneficial to operate this at least one first-time frequencies in several steps, starting with e.g. a first wake up frequency being ½ day, then 1 day, then 2 days, then 6 days and have 2 weeks or even more the lowest wake-up frequency because it is more likely than not that the logger device will be used within few hours or days.

The transport mode may be in a form of a pending message coming from the external data processing device, that may be transmitted to the logger device, where the message may e.g. contain information about the coordinates of the origin and destination location of the asset, details about the environmental related parameters to monitor, such as the temperature, and various boundaries such as maximum and/or minimum allowable temperature, the way how to start the logger device (e.g. manual) etc. Other information may be the geofence radius at the origin and destination location. This should of course not be construed as being limited to the temperature parameter, but as discussed in more detail later, environmental parameters such as humidity, air pressure etc. may also be defined in this message.

In an embodiment, the method further comprises, in case the checking results in that the logger device is not to be set to a transport mode:
adjusting the logger device to a second low-power mode and adjusting the communication frequency with the external data processing device to at least one third-time frequency, where the at least one third-time frequency is lower than the second-time frequency.

In an embodiment, the at least one third-time frequency is the same as the at least one first-time frequency.

In an embodiment, the at least one third-time frequency is selected from two or more gradually decreasing frequencies until a minimum pre-defined third-time frequency is reached. This may be of particular relevance if an event, e.g. vibration, is detected to follow up on it to make sure that this was e.g. just a one-time vibration because of e.g. accidental movement of the box, or if this is the first step in placing the logger device in actual transport mode.

In an embodiment, the resulting environmental related data is selected from:
acceleration data such as vibration,
air pressure data,
light intensity data,
temperature data,
humidity data,
a combination of one or more of the above.

In an embodiment, the step of adjusting the logger device to the second higher energy mode and checking if the logger device is to be set to transport mode comprises checking via a communication network such as 2G, 3G, 4G, 5G cellular network if an asset order for the logger device is pending or not. The communication module may in an embodiment comprise a modem and where the step of adjusting the logger device to the second higher energy mode comprises adjusting the modem from being in a low-power mode or being switched off to a higher-power mode where the modem communicates with the communication network.

In an embodiment, the first higher-energy mode is the same as the second higher-energy mode. This may as an example be when the modem is turned on to communicate with the communication network.

In an embodiment, the communication module comprises a wireless sniffing module (detector) configured to identify presence of wireless network(s), wherein the method further comprises, prior to the step of adjusting the logger device to the second higher energy mode:
identifying the presence of wireless network(s) and comparing the identified network(s) to previously identified network(s), where in case of at least a partial match between the identified network(s) to the previously identified network(s) the logger device remains in the low energy mode. In an embodiment, in case of a non-match between the identified network(s) and the previously identified network(s) of the logger device, said step of adjusting the logger device to the second higher energy mode is performed.

The energy required to activate such a wireless sniffing module such as a Wi-Fi sniffer, is much less compared to adjusting the logger device to the second higher energy mode where e.g. the communication module can communicate with the cellular network. This means that such a low power intermediate step results in further power savings for the power source. Therefore, in the scenario where e.g. a person lifts or accidentally bumps into an empty box (detected as a vibration) to be used for the transport of the asset with an associated logger device at the origin location (e.g. a warehouse) the logger device will not fully wake-up because the sniffing module will notice that the box is still at the location where it should be. In an embodiment, this sniffing feature might be repeated several times, e.g. every 30 minutes for the next 6 hours, to ensure that the empty box is not leaving the origin location.

The term transport mode may according to the present invention be understood as another mode of operating the logger device, such as but not limited to, measure one or more of said environmental related parameters more frequently and/or communicating the resulting measured environmental related data with the external data processing device along with the position of the asset with a pre-defined higher frequency, while this may e.g. be done every hour, the measuring process itself may be performed every 10 minutes, meaning that every hour a single coordinate location is transmitted together with 6 different measurement data such as temperature measurements and/or an average value of the 6 measurements. This frequency may also depend on the type of transport, such as if the transport is a car, ship, or an aircraft etc.

In an embodiment, the step of setting the logger device to the transport mode is performed automatically, such as via the external data processing device, which may e.g. according to the present invention be understood as a cloud platform solution.

In an embodiment, the automatic setting comprises using a pre-defined geofence boundary distance from the origin location of the asset to automatically trigger the automatic setting. This may be based on utilizing the received coordinate position of the logger device at the origin location where e.g. when the asset is x km away from the origin location the transport mode may be triggered automatically.

In an embodiment, the resulting environmental related data comprises acceleration data such as a vibration of the asset measured by an accelerometer comprised in the logger device, wherein the step of automatically adjusting the logger device to transport mode is performed if measured acceleration/vibrations remain within a defined acceleration/vibration interval for a pre-defined time period thus indicating a consistency in the measured acceleration/vibrations. This might e.g. be a scenario where the asset is in a transport vehicle where after some time, after detecting a similar vibration for some time exceeding the pre-defined time period, the transport mode is automatically started.

In one embodiment, the method further comprises detecting if the logger device is in the vicinity or onboard of an aircraft by means of checking by the communication module if an aviation related aircraft signal, such as an Automatic Dependent Surveillance-Broadcast (ADS-B) signal, is received, where in case such an aircraft signal is received and preferably also a detected vibration is measured, the asset is then automatically registered as being onboard of an aircraft and the logger device is adjusted to transport mode. This may be done by a receiver suitable to detect the aviation related aircraft signals, as an example, it could be a TV-tuner.

Based on the above, starting such an asset automatically instead of manually makes the overall process of starting the transport more user friendly, efficient, and moreover avoids possible human failures in forgetting to set the logger device to transport mode.

In an embodiment, the resulting environmental related data comprises the ambient air pressure at or around the asset measured by a barometer, wherein the step of automatically adjusting the logger device to transport mode is performed if the difference in the measured air pressure exceeds a pre-defined limit and remains such over a pre-defined time period thus indicating a consistency in the measured air pressure difference. This may as an example be the case where the asset is in an aircraft. The logger device and thus the asset may automatically identify that they are on board an aircraft and the logger device may thus be set automatically to transport mode, instead of said manual starting process.

In one embodiment, the event is an interrupt condition alert signal configured to alert the processor to interrupt the currently executed first low-power mode and transfer it to the second higher energy mode. Such an interrupt signal may generally be emitted by hardware or software when a process or an event needs immediate attention. In this case, it may be a sudden increase in light intensity or an increase in vibration, without these measuring devices having to measure on a regular basis. Accordingly, a solution is provided to enable the triggering of the event in a highly energy efficient manner.

In another embodiment, the event is sensed by means of identifying, by the processor, if there is a deviation in the measured environmental related data from the previously measured environmental related data that exceeds a pre-defined deviation limit.

In an embodiment, the first low-power mode is the same as the second low-power mode.

The logger device is preferably a multi-use logger device where e.g. the power source comprises re-chargeable batterie(s). The power source may be one or more batteries, e.g. standard alkaline AA or AAA battery, e.g. lithium-ion battery. The power source may also be a thin bendable battery, having thickness in the millimeter range or even smaller (less than a millimeter), where electronic components may include printed circuit, meaning that the thickness of the logger device may be few millimeter of thickness.

In a second aspect of the invention, the present invention relates to a wireless logger device configured to monitor an environmental related parameter of an asset while the asset is transported from an origin location to a destination location, where the logger device comprises:
a power source for powering the logger device,
a storage medium,
a sensing device for sensing an environmental related parameter of the asset,
a communication module,
a processor for operating the power source, the storage medium, the sensing device and the communication module,
   wherein the processor is configured to set the communication module in a first low-power mode where the environmental related parameter is measured by the sensing device and where the resulting environmental related data is stored in the storage medium, where in the low-power mode the communication module communicates with an external data processing device with at least one first-time frequency by means of temporarily setting the logger device to a first higher-energy mode during the communication with the external data processing device,
   wherein the processor is operable connected to the sensing device and the communication module and is further configured to, in case an event is sensed by the sensing device, to adjust the communication module and thus the logger device to a second higher energy mode, where in the second higher energy mode, to check if the logger device is to be set to transport mode, where in case the checking results in that the logger device is to be set to a transport mode, set the logger device to a transport mode and adjust the communication frequency with the external data processing device to a second-time frequency, the second-time frequency being larger than the first-time frequency,
   where in case the checking results in that the logger device is not to be set to transport mode, the processor is further configured to adjust the logger device to a second low-power mode and adjust the communication frequency with the external data processing device to at least one third-time frequency, the at least one third-time frequency being lower than the second-time frequency.

In an embodiment, the sensing device comprises a temperature sensor for measuring the temperature of the asset and/or an accelerometer for measuring the acceleration data such as a vibration and/or light sensor for measuring light intensity, and/or a barometer for measuring air pressure.

Since the temperature is commonly a critical environmental parameter during the transport, it may not be that relevant to measure the temperature on a regular basis prior to starting the transport as it is commonly done today while the logger devices are stored in warehouses prior to transport, but instead, it may be relevant to measure the vibrations and/or light intensity so as to enable said event detection, e.g. sudden increase in vibration and/or light intensity. Thus, to ensure further power saving of the logger device's power source prior to transport, one or both the accelerometer sensor and the light intensity sensor are turned completely or partially on but the temperature sensor is turned off, when the detected event(s) includes acceleration such as vibration and/or light intensity.

In a third aspect of the invention, the present invention relates to a system for operating a wireless logger device where the logger device is configured to monitor an environmental related parameter of an asset while the asset is transported from an origin location to a destination location, where the logger device comprises:
a power source for powering the logger device,
a storage medium,
a sensing device for sensing an environmental related parameter of the asset,
a communication module,
a processor for operating the power source, the storage medium, the sensing device, and the communication module.

The system comprises:
an external data processing device configured to instruct the processor to set the logger device to a first low-power mode where the environmental related parameter is measured by the sensing device and where the resulting environmental related data is stored in the storage medium, where in the low-power mode the communication module communicates with the external data processing device with at least one first-time frequency by means of temporarily setting the logger device to a first higher-energy mode during the communication with the external data processing device,
   wherein the sensing device is configured to sense if an event is detected in/around the logger device, where in case an event is sensed, the processor adjusts the logger device to a second higher energy mode, where in the second higher energy mode:
checking if the logger device is to be set to transport mode, where in case the checking results in that the logger device is to be set to transport mode,
setting the logger device to transport mode and adjusting the communication frequency with the external data processing device to a second-time frequency, the second-timer frequency being larger than the first-time frequency.

In an embodiment, the processor is further configured in case the checking results in that the logger device is not to be set to transport mode, to adjust the logger device to a second low-power mode and adjust the communication frequency with the external data processing device to at least one third-time frequency, the at least one third-time frequency being lower than the second-time frequency.

In general, the various aspects of the invention may be combined and coupled in any way possible within the scope of the invention. These and other aspects, features, and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 illustrates schematically a common cycle of using a logger device according to the present invention in a real time global supply chain monitoring for monitoring an asset while transporting the asset from an origin location to a destination location,

FIG. 2 shows an embodiment of a logger device according to the present invention,

FIG. 3 shows an embodiment of a flowchart of a method according to the present invention for operating a wireless logger device discussed in relation to FIG. 2,

FIGS. 4 and 5 illustrate graphically two scenarios of the logger device discussed in relation to FIGS. 2 and 3 when the logger device is placed in e.g. a warehouse prior to be in actual transport, and

FIG. 6 depicts graphically a scenario where two events are detected, E1 and E2, during a lower power mode of the logger device.

### DESCRIPTION OF EMBODIMENTS

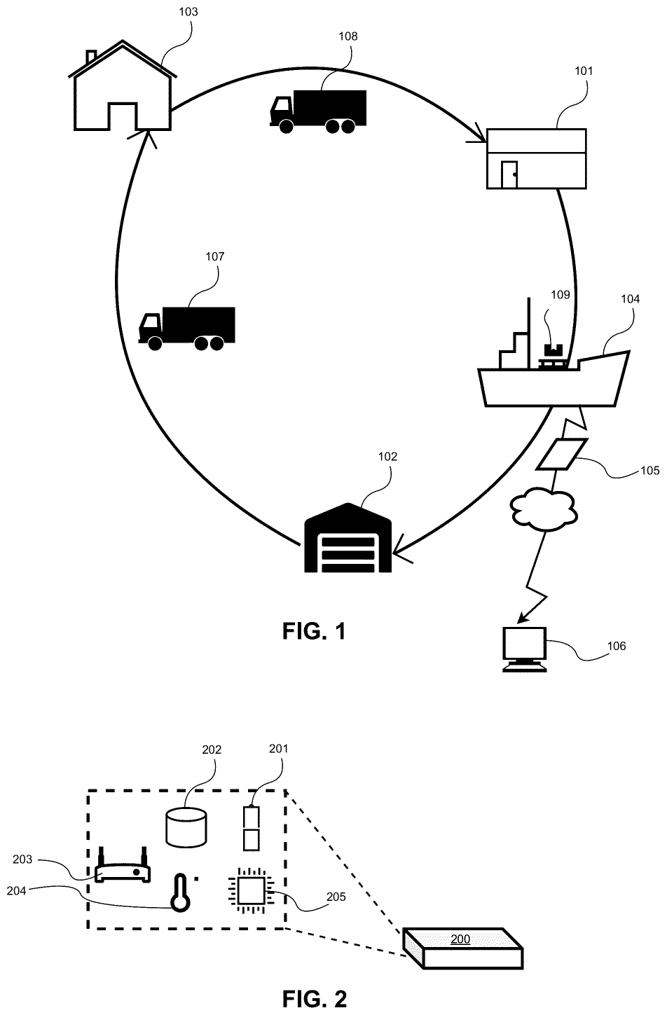

FIG. 1 illustrates schematically a common cycle of using logger device 200, preferably a multi-use logger device, according to the present invention as illustrated in FIG. 2, in a real time global supply chain for monitoring an asset 109 while transporting the asset (e.g. medicine or food and/or beverages) from an origin location 101, which may be a warehouse of a customer, to a destination location 102. As illustrated in this example, the transportation is done by a ship 104, but could, of course, be any mode of transport, e.g. a vehicle, aircraft etc., the logger regularly sends environmental related data 105 such as the temperature of the asset and/or acceleration data and/or vibration etc. along with the location of the asset to an external data processing device 106, that may be any type of e.g. a cloud-platform system.

As will be discussed in more detail later, such a logger device 200 comprises a power source for powering the logger device 201 such as a re-chargeable battery, a storage medium 202, a sensing device 204 for sensing an environmental related parameter of the asset 109, a communication module 203, and a processor 205 for operating the power source, the storage medium, the sensing device, and the communication module.

After arriving at the destination location where the monitoring is completed, the logger device is transported by a transport means 107 from the destination location 102 to service center 103, where the logger device is returned and charged and, in some instances, re-calibrated, in particular the temperature sensor, associated to the logger devices.

Subsequently, the logger device is transported back to the origin location 101 where it is stored until the next transport starts.

The path from the destination location 102 to the service center 103 is not important for the customer because the transport is completed. Also, the transport from service center 103 to the origin location 101 is often relatively short and the logger devices are in low power mode during the transport and therefore this path is also not critical.

It should be noted that in praxis hundreds or thousands of such logger devices according to the present invention are transported to the service center 103 and from the service center to the origin location 101.

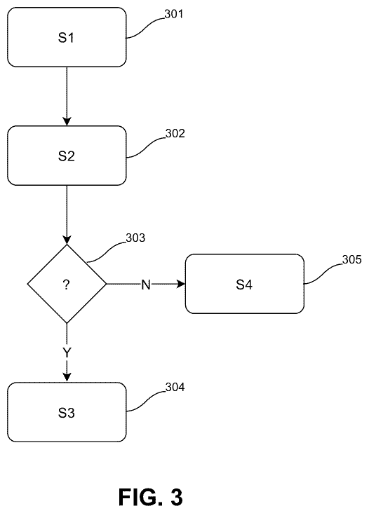

FIG. 3 shows an embodiment of a flowchart of a method according to the present invention for operating a wireless logger device 200 discussed in relation to FIG. 2, where the logger device 200 is configured to monitor an environmental related parameter of an asset in real-time while the asset is being transported from the origin location 101 to the destination location 102. The term “real-time” in such a supply chain monitoring as depicted in FIG. 1 means sending location data of the asset (and the logger device) and measured environmental data such as temperature of the asset on a regular basis, where e.g. the temperature may be measured every 10 minutes, and where the temperature of the asset along with the location of the asset may be sent to the external data processing device 106 every one hour, that is if the signal strength is sufficient (e.g. if there is a 3G or 4G connection available).

The method according to the present invention is particularly relevant for operating the logger device while it is stored at the origin location 101 and until it enters transport mode where it is associated with the asset, e.g. such as the one illustrated graphically in FIG. 1.

In a first step (S1) 301, the logger device is set in a first low-power mode where the environmental related parameter such as the temperature of the asset, vibration, light intensity, humidity, or a combination thereof, are measured and stored in the storage medium. In this low-power mode, the communication module communicates with an external data processing device with at least one first-time frequency by means of temporarily setting the logger device to a first higher-energy mode during the communication with the external data processing device. As an example, the first-time frequency may be 5 days meaning that the logger device is in a lower power mode during the 5 days, but where it has sufficient energy to measure one or more of said environmental related parameters and store the resulting data in the storage medium 202 during said days. This low-power mode is then temporarily changed to a first higher-energy mode, where in this first higher-energy mode the logger device has sufficient energy to enable the communication module to connect to e.g. a cellular network (if there is a sufficient signal strength) where the measured data along with the position of the logger device are transmitted. The position may as an example be determined using cellular triangulation. This temporal change to the first-higher energy mode may be just for a minute or so. This is more or less to give information about the status of the logger device, in particular the battery life, and the environmental condition such as the temperature in the warehouse.

In an embodiment, the at least one first-time frequency is selected from two or more gradually decreasing frequencies until a minimum first-time pre-defined frequency is reached. This may be beneficial since in most cases the logger device is used within a few hours or days, meaning that initially the logger device is in a “stand-by” mode to receive a transport message from the external processing device 106 and be ready for transport. Thus, instead of going directly into said 5 day wake-up mode, it may do it gradually in several steps, e.g. starting with just a few hours wake-up frequency, then 1 day, 2 days, and finally 5 days.

In a second step (S2) 302, a detection step is performed by the sensing device 204 where it is detected if an event is sensed. The event may be an interrupt condition alert signal configured to alert the processor of the logger device to interrupt the currently executed first low-power mode. This may as an example be the case where a logger device is suddenly moved and where a certain vibration above a pre-defined range is suddenly detected by e.g. an accelerometer, and/or if an amount of light intensity is detected that goes above a certain light intensity range. If such an event is detected, the logger device is transferred to a second higher energy mode. The second higher energy mode may be the same energy mode as the first higher energy mode discussed previously, namely an energy mode sufficient to adjust the communication module such that the logger device is capable of communicating with e.g. a cellular network, such as 2G, 3G, 4G, and 5G.

In a checking step 303, the logger device checks, while it is in the second higher energy mode, if it is to be set to transport mode or not, or is to be prepared to start the transport mode. This may be done by checking if there is a shipping message pending from the external data processing device 106. The message may e.g. contain information about coordinates of the origin and destination location of the asset, details about environmental related parameters to monitor, such as which environmental related parameter to monitor, and various boundaries such as maximum/minimum allowable ranges of the environmental related parameter. Other information may include geofence radius at the origin and destination location.

In a third step (S3) 304, if the checking step positively confirms that the logger device is to be set to the transport mode, the shipping message with all the associated information is downloaded by the logger device and the logger device is ready for transport, meaning e.g. all said information to be set to transport mode are stored in the logger device. At this moment, or after the transport has started, the communication frequency is adjusted to a second-time frequency that is larger than the first-time frequency. The shipping message includes amongst other information how the transport mode is to be started, e.g. if it is a manual operation where an operator starts the logger device manually via e.g. “On button” on the logger device, or if it is to be done automatically.

In a fourth step (S4) 305, if the checking does not confirm that the logger device is to be set to transport mode, the logger device is adjusted to a second low-power mode, which may be the same as the first low-power mode, and the communication frequency with the external data processing device is adjusted to at least one third-time frequency, which may be identical to the first communication frequency. In an embodiment, the at least one third-time frequency is selected from two or more gradually decreasing frequencies until a minimum pre-defined third-time frequency is reached. This may be beneficial as a safety measure to make sure that the detected event was a “false alarm” since it may take minutes and maybe up to a few hours to ensure that this was a false alarm. This may also depend on if the detected event is just a one-time event, e.g. a sudden increase in vibration and subsequently no vibration, which would point towards that the detected event is not the start of the shipment, whereas several subsequent such events might be an indication that the logger device is being prepared for actual transport which would then be identified via said two or more gradually decreasing frequencies.

In an embodiment, the method comprises an intermediate step prior to setting the logger device in the second higher energy mode, where the communication module comprises a wireless sniffing module such as Wi-Fi sniffer, configured to identify presence of wireless network(s), whereby prior to the step of adjusting the logger device to the second higher energy mode, the method comprises identifying the presence of wireless network(s) and comparing the identified network(s) to previously identified network(s), where in case of at least a partial match between the identified network(s) to the previously identified network(s) the logger device remains in low energy mode. This may be repeated several times to ensure that the detected network(s) are still present. As an example, if the logger device is accidentally moved which causes a vibration, it might be possible that this logger device is being moved e.g. from said warehouse (origin location) and is being prepared to be placed with an asset. Thus, it may be possible that it will take some time until the logger device is outside of the warehouse. Accordingly, doing this check a few times ensured that this kind of scenario is accounted for. If this frequency is let's say four times, every ten minutes, and each time the presence of the wireless network(s) is detected, that will confirm that the logger device is still in the warehouse and is not to be placed with an asset.

However, in case of a non-match between the previously identified network(s) to the previously identified network(s) of the logger device, said step of adjusting the logger device to the second higher energy mode is performed.

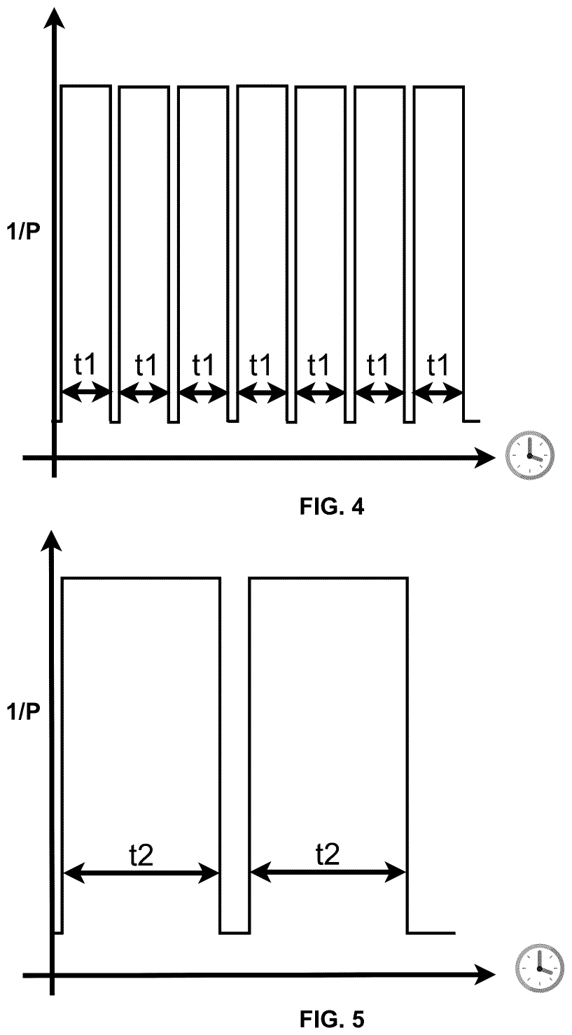

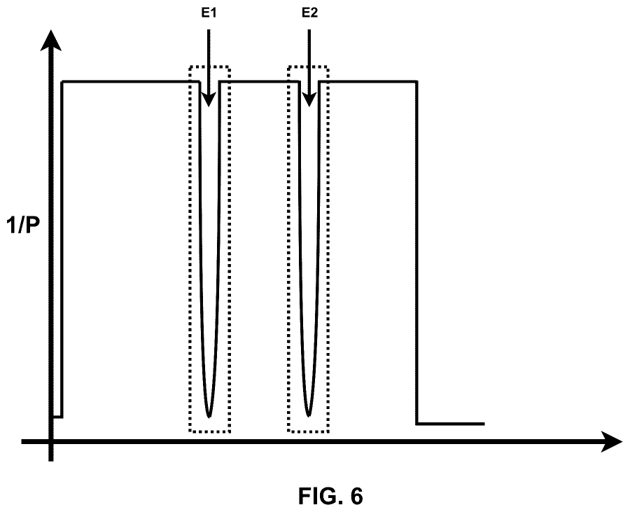

FIGS. 4 and 5 illustrate graphically two scenarios of the logger device discussed in relation to FIGS. 2 and 3 when the logger device is placed in e.g. a warehouse prior to being in actual transport, where FIG. 4 depicts higher wake-up frequency, e.g. once every day, compared to a lower wake-up frequency in FIG. 5, e.g. once every five days. The y-axis depicts 1/Power (P) and the horizontal axis is time. The upper horizontal portions reflect low power mode, and the lower horizontal lines depict higher energy mode where the logger device is e.g. connected to a cellular network. The tail portion of the graphs illustrates where the logger device is in a higher energy mode and is e.g. downloading the transport message and the relevant information comprised in the message. The message may be in different formats, such as, but not limited to, a text message, email etc. These two different wake-up modes illustrate graphically how energy consuming it is if the logger devices wakes up with higher frequency as illustrated in FIG. 4 compared to FIG. 5.

FIG. 6 depicts graphically a scenario where two events are detected, E1 and E2, during the lower power mode of the logger device. As already mentioned, such events may be caused due to e.g. interruptions where the logger device may e.g. be associated with an empty box, where the box is accidentally moved causing sudden increase in vibrations, or the box may be opened causing a sudden increase in light intensity. These events trigger an adjustment to said second higher energy mode for checking e.g. via a cellular network if the logger device is to be set to transport mode. In this scenario, for time period around E1 and E2, no transport message is pending meaning the logger device is adjusted back to the previous low power mode. The tail part however indicates that the logger device is in a higher energy mode and is e.g. downloading the transport message and the relevant information comprised in the message.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art of practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1.-20. (canceled)

21. A method of operating a wireless logger device where the logger device is configured to monitor an environmental related parameter of an asset while the asset is transported from an origin location to a destination location, where the logger device comprises:
a power source for powering the logger device,
a storage medium,
a sensing device for sensing an environmental related parameter of the asset,
a communication module, a processor for operating the power source, the storage medium, the sensing device and the communication module,
the method comprising:
setting, by the processor, the logger device in a first low-power mode where the environmental related parameter is measured by the sensing device and where the resulting environmental related data is stored in the storage medium, where in the low-power mode the communication module communicates with an external data processing device with at least one first-time frequency by means of temporarily setting the logger device to a first higher-energy mode during the communication with the external data processing device,
wherein the method further comprises:
detecting if an event is sensed by the sensing device, where in case an event is sensed:
adjusting, by the processor, the logger device to a second higher energy mode and:
checking if the logger device is to be set to a transport mode, where in case the checking results in that the logger device is to be set to a transport mode,
setting the logger device to a transport mode and adjusting a communication frequency with the external data processing device to a second-time frequency, the second-time frequency being larger than the first-time frequency.

22. The method according to claim 21, further comprising in case the checking results in that the logger device is not to be set to a transport mode:
adjusting the logger device to a second low-power mode and adjusting the communication frequency with the external data processing device to at least one third-time frequency, the at least one third-time frequency being lower than the second-time frequency.

23. The method according to claim 21, wherein the step of adjusting the logger device to the second higher energy mode and checking if the logger device is to be set to a transport mode comprises checking via a communication network such as a cellular network if an asset order for the logger device is pending or not.

24. The method according to claim 23, wherein the communication module comprises a modem and where the step of adjusting the logger device to the second higher energy mode comprises adjusting the modem from being in a low-power mode or be switched off to a higher-power mode where the modem communicates with the communication network.

25. The method according to claim 21, wherein the communication module comprises a wireless sniffing module configured to identify presence of wireless network(s), wherein the method further comprises, prior to the step adjusting the logger device to the second higher energy mode:
identifying the presence of wireless network(s) and compare the identified network(s) to previously identified network(s), where in case of at least partially match between the identified network(s) to the previously identified network(s) the logger device remains in a low energy mode.

26. The method according to claim 25, wherein in case of non-match between the identified network(s) to the previously identified network(s) of the logger device, said step of adjusting the logger device to the second higher energy mode is performed.

27. The method according to claim 21, wherein the resulting environmental related data is selected from:
acceleration and/or vibration data,
air pressure data,
light intensity data,
temperature data,
humidity data,
a combination of one or more of the above.

28. The method according to claim 21, wherein the step of setting the logger device to the transport mode is performed automatically.

29. The method according to claim 28, wherein the automatic setting comprises using a pre-defined geofence boundary distance from the origin location of the asset to automatically trigger the automatic setting.

30. The method according to claim 27, wherein the resulting environmental related data comprises acceleration data such as a vibration of the asset measured by an accelerometer,
wherein the step of automatically setting the logger device to transport mode is performed after measured acceleration data such as the vibrations remain within a defined vibration interval for a pre-defined time period thus indicating a consistency in the measured acceleration data.

31. The method according to claim 21, further comprising detecting if the logger device is in vicinity or onboard of an aircraft by means of checking by the communication module if an aviation related aircraft signal, such as Automatic Dependent Surveillance-Broadcast (ADS-B) signal, is received, where in case such an aviation related aircraft signal is received and a detected acceleration data such as a vibration is measured, the asset is then automatically registered as being onboard of an aircraft and the logger device is adjusted to transport mode.

32. The method according to claim 27, wherein the resulting environmental related data comprises air pressure around the asset measured by a barometer,
wherein the step of automatically adjusting the logger device to transport mode is performed after measured air pressure difference exceeds a pre-defined limit and remains such over a pre-defined time period thus indicating a consistency in the measured air pressure difference.

33. The method according to claim 21, wherein the at least one first-time frequency is selected from two or more gradually decreasing frequencies until a minimum first-time pre-defined frequency is reached.

34. The method according to claim 21, wherein the at least one third-time frequency is selected from two or more gradually decreasing frequencies until a minimum pre-defined third-time frequency is reached.

35. The method according to claim 21, wherein the event is an interrupt condition alert signal configured to alert the processor to interrupt the currently executed first low-power mode and transferring it to the second higher energy mode.

36. The method according to claim 21, wherein the event is sensed by means of identifying, by the processor, if there is a deviation in the measured environmental related data from previous measured environmental related data that exceeds a pre-defined deviation limit.

37. The method according to claim 21, wherein the first low-power mode is the same as the second low-power mode and/or where the first higher-energy mode is the same as the second higher-energy mode.

38. A wireless logger device configured to monitor an environmental related parameter of an asset while the asset is transported from an origin location to a destination location, where the logger device comprises:
a power source for powering the logger device,
a storage medium,
a sensing device for sensing an environmental related parameter of the asset,
a communication module,
a processor for operating the power source, the storage medium, the sensing device and the communication module,
wherein the processor is configured to set the communication module in a first low-power mode where the environmental related parameter is measured by the sensing device and where the resulting environmental related data is stored in the storage medium, where in the low-power mode the communication module communicates with an external data processing device with at least one first-time frequency by means of temporarily setting the logger device to a first higher-energy mode during the communication with the external data processing device,
wherein the processor is operable connected to the sensing device and the communication module and is further configured to, in case an event is sensed by the sensing device, to adjust the communication module and thus the logger device to a second higher energy mode, where in the second higher energy mode, to check if the logger device is to be set to a transport mode, where in case the checking results in that the logger device is to be set to a transport mode, set the logger device to a transport mode and adjust the communication frequency with the external data processing device to a second-time frequency, the second-timer frequency being larger than the first-time frequency,
where in case the checking results in that the logger device is not to be set to a transport mode,
the processor is further configured to adjust the logger device to a second low-power mode and adjust the communication frequency with the external data processing device to at least one third-time frequency, the at least one third-time frequency being lower than the second-time frequency.

39. A system for operating a wireless logger device where the logger device is configured to monitor an environmental related parameter of an asset while the asset is transported from an origin location to a destination location, where the logger device comprises:
a power source for powering the logger device,
a storage medium,
a sensing device for sensing an environmental related parameter of the asset,
a communication module,
a processor for operating the power source, the storage medium, the sensing device and the communication module,
the system comprising:
an external data processing device configured to instruct the processor to set the logger device in a first low-power mode where the environmental related parameter is measured by the sensing device and where the resulting environmental related data is stored in the storage medium, where in the low-power mode the communication module communicates with the external data processing device with at least one first-time frequency by means of temporarily setting the logger device to a first higher-energy mode during the communication with the external data processing device,
wherein the sensing device is configured to sense if an event is detected in the logger device, where in case an event is sensed, the processor adjusts logger device to a second higher energy mode, where in the second higher energy mode:
checking if the logger device is to be set to a transport mode, where in case the checking results in that the logger device is to be set to a transport mode,
setting the logger device to a transport mode and adjusting the communication frequency with the external data processing device to a second-time frequency, the second-time frequency being larger than the first-time frequency.

40. The system according to claim 39, wherein the processor is further configured to, in case the checking results in that the logger device is not to be set to a transport mode, to adjust the logger device to a second low-power mode and adjusting the communication frequency with the external data processing device to at least one third-time frequency, the at least one third-time frequency being lower than the second-time frequency.
